(19) United States
(12) Patent Application Publication
(10) Pub. No.: US 2007/0299769 A1
(43) Pub. Date: Dec. 27, 2007

(54) LENDER SELECTION SYSTEM AND METHOD

(75) Inventors: William V. Fowler, Port Ludlow, WA (US); Jami E. Goers, Bremerton, WA (US); Richard D. Durr, Bremerton, WA (US)

Correspondence Address: AXIOS LAW GROUP. PLLC, 1525 FOURTH AVENUE, SUITE 800, SEATTLE, WA, 98101, US

(73) Assignee: E-NET FINANCIAL SERVICES, INC., Port Ludlow, WA (US)

(21) Appl. No.: 11/766,584

(22) Filed: Jun. 21, 2007

Related U.S. Application Data
(60) Provisional application No. 60/805,361, filed on Jun. 21, 2006.

(51) Int. Cl. G06Q 40/00

(52) U.S. Cl. 705/38

(57) ABSTRACT

Systems and methods are provided herein for selecting and soliciting a plurality of lenders. In one exemplary embodiment, a loan originator obtains lending criteria of a plurality of lenders, which can include lender desking criteria, product criteria, and finance and insurance criteria. The originator then obtains applicant lending data of an applicant, which can comprise the applicant's personal data, bureau data, desking data, product data, and finance and insurance data. The applicant lending data is compared to the lending criteria of each of the plurality of lenders and lenders that are likely grant the applicant a loan are presented. The loan originator can then select one or more lender and submit a loan application to the selected lenders.

### RELATED REFERENCES

This application claims priority to U.S. Provisional Application 60/805,361 filed Jun. 21, 2006. The foregoing application is hereby incorporated by reference in its entirety as if fully set forth herein.

### FIELD

This invention relates generally to obtaining financing, and more specifically, to systems and methods for selecting and soliciting a plurality of lenders.

### BACKGROUND

Purchasing vehicles and homes are some of the largest and most significant transactions that most people will make in their lives. Typically, buyers of homes and vehicles obtain a loan when making their purchase, which can be a complicated and confusing process for many. For individual consumers, or institutions that act as agents for consumers, the process of shopping for a loan typically begins by obtaining a credit history and/or credit score for the consumer and submitting loan applications to a large number of lenders. Each lender must evaluate the application submitted to them and it can take a long time to receive a decision back from each lender. While this process makes it likely that at least one lender will approve a loan for the applicant, it is time consuming for buyers, loan brokers, and lenders alike.

Additionally, for loan brokers specifically, the Equal Credit Opportunity Act (ECOA) imposes strict non-discrimination and disclosure requirements, which create a great liability when these companies make adverse lending decisions. Unfortunately, the current process, naturally generates a large number of adverse lending decisions for loan brokers, and exposes them to potential discrimination suits from loan applicants, especially those with poor credit histories.

Moreover, a given applicant or loan broker typically does not know or does not account for the factors that effect the lending decision of each lender that they submit an application to. The criteria that lenders use to evaluate and approve loans varies substantially from lender to lender, and failing to take this into account when applying for loans from these lenders makes it more likely that the applicant will be rejected outright, or that the loan will be declined after further investigation and disclosure of additional facts by the applicant.

### BRIEF DESCRIPTION OF THE DRAWINGS

The present invention will be described by way of exemplary embodiments but not limitations, illustrated in the accompanying drawings in which like references denote similar elements, and in which:

FIG. 1 is a pictorial diagram of a system of interconnected devices that facilitate selection and solicitation of a lender in accordance with various embodiments.

FIG. 2 is a block diagram of a device that provides an exemplary operating environment for an embodiment.

FIG. 3 is a diagram illustrating the actions taken by a loan originator when selecting and soliciting a lender in accordance with various embodiments.

FIG. 4 is a flow diagram illustrating a routine for selecting and soliciting at least one lender in accordance with various embodiments.

FIG. 5 is a flow diagram illustrating a sub-routine for selecting at least one lender in accordance with various embodiments.

FIG. 6 is a diagram illustrating the actions taken by a lender evaluating a lending applicant in accordance with various embodiments.

FIG. 7 is a flow diagram illustrating a routine for evaluating a lending applicant and restructuring a loan in accordance with various embodiments

### DESCRIPTION

Illustrative embodiments presented herein include, but are not limited to, systems and methods for selecting and soliciting a plurality of lenders, and systems and methods for evaluating lending applicants and restructuring loans.

Various aspects of the illustrative embodiments will be described using terms commonly employed by those skilled in the art to convey the substance of their work to others skilled in the art. However, it will be apparent to those skilled in the art that the embodiments described herein may be practiced with only some of the described aspects. For purposes of explanation, specific numbers, materials and configurations are set forth in order to provide a thorough understanding of the illustrative embodiments. However, it will be apparent to one skilled in the art that the embodiments described herein may be practiced without the specific details. In other instances, well-known features are omitted or simplified in order not to obscure the illustrative embodiments.

Further, various operations and/or communications will be described as multiple discrete operations and/or communications, in turn, in a manner that is most helpful in understanding the embodiments described herein; however, the order of description should not be construed as to imply that these operations and/or communications are necessarily order dependent. In particular, these operations and/or communications need not be performed in the order of presentation.

The phrase “in one embodiment” is used repeatedly. The phrase generally does not refer to the same embodiment; however, it may. The terms “comprising,” “having” and “including” are synonymous, unless the context dictates otherwise.

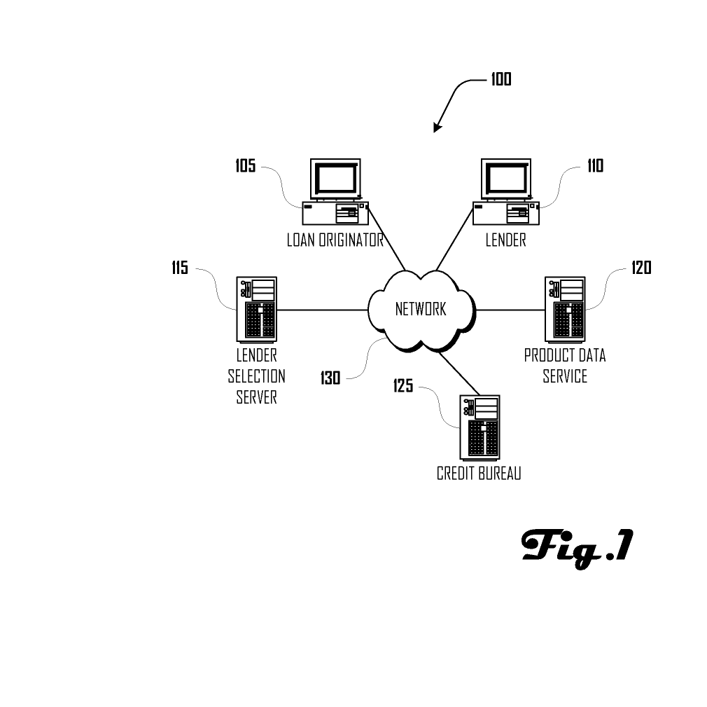

FIG. 1 illustrates a plurality of devices used in an exemplary system 100 of one embodiment. The system 100 comprises a loan originator 105, a lender 110, a lender selection server 115, a product data service 120, and a credit bureau 125, all of which are operationally connected to each other via a network 130.

It will be appreciated by one of ordinary skill in the art that there can be a plurality of loan originators 105, lenders 110, lender selection servers 115, product data services 120, credit bureaus 125 and networks 130. Moreover, one or more of these devices or networks can be absent in various embodiments.

In one exemplary embodiment, the loan originator 105 can be any company, person or other entity that sells or deals in goods or services where its customers can use a loan to pay for the goods or services. The loan originator 105 can be a company, person or other entity such as a vehicle dealership, real estate company, construction company, home furnishing company, department store, jeweler or the like. Alternatively, the loan originator 105 can be a loan or mortgage broker, a lender, a branch of a lender, or an individual person, business or other entity that desires a loan, or the like.

In a further exemplary embodiment, the lender 110 can be any type of company, institution, person or other entity that can lend money. The lender 110 can be an individual lender or investor. The lender 110 can also be a bank, investment group, or other public or private lending institution. Additionally, as discussed herein, there can be a plurality of lenders 110.

In one embodiment, the lender selection server 115 can be a local or remote server as compared to the loan originator 105, the loan originator 105 can be directly connected to the lender selection server 115, or the lender selection server 115 itself can be or act as a loan originator 105. The lender selection server 115 can store information, including but not limited to lender lending criteria, loan pass/fail data, and applicant lending data. Applicant lending data can comprise applicant personal data, applicant credit data, product data, applicant desking data, finance and insurance data, or the like. Additionally, applicant non-bureau data comprises applicant personal data, product data, applicant desking data, finance and insurance data, or the like, but not applicant credit data obtained from a credit bureau. Also, applicant bureau data can comprise applicant credit data obtained from a credit bureau, but not applicant personal data, product data, applicant desking data, finance and insurance data, or the like. Moreover, applicant loan purpose data can comprise any information about the one or more product or service that the applicant desires to purchase, which can include product data. Also, lender lending criteria can comprise lender desking criteria, lender product criteria, and lender finance and insurance criteria, lender personal data criteria, lender credit data criteria, lender non-bureau criteria, lender bureau criteria, lender loan purpose data criteria, or the like.

In one exemplary embodiment, the product data service 120 can be any company, service, or provider that can provide one or more piece of information about at least one product or service. For example, the product data service can be a vehicle dealer management system (DMS), which can be a remote or local application in relation to the loan originator 105. DMS systems are well known in the art, examples of which are produced by Automatic Data Processing, Inc., Reynolds & Reynolds Co., and Arkona, Inc.

In another exemplary embodiment, the credit bureau 125 can be a consumer reporting agency, credit reference agency, or credit bureau including, but not limited to, Experian, Inc., Equifax, Inc. TransUnion LLC, Callcredit Ltd., or the like.

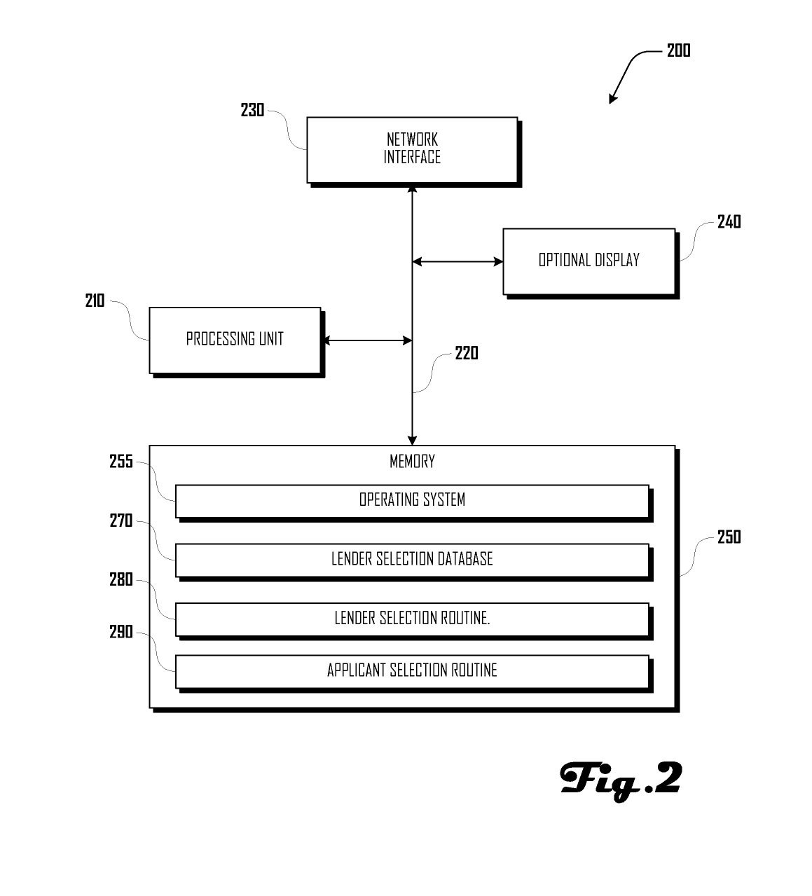

FIG. 2 illustrates several components of an exemplary operating environment 200 for an embodiment. For example, the loan originator 105, lender selection server 115, or lender 110 can be embodied in the operating environment 200 depicted in FIG. 2. Those of ordinary skill in the art and others will appreciate that the operating environment 200 may include many more components than those shown in FIG. 2. However, it is not necessary that all of these generally conventional components be shown in order to disclose an enabling embodiment for practicing the embodiments described herein. As shown in FIG. 2, the operating environment 200 includes a network interface 230 for connecting to remote devices (not shown). The network interface 230 may be a network interface designed to support a local area network (LAN), wireless local area network (WLAN), personal area network (PAN), telephone network, powerline connection, serial bus, universal serial bus (USB) wireless connection, or the like. The network interface 230 includes the necessary circuitry, driver and/or transceiver for such a connection and is constructed for use with the appropriate protocols for such a connection.

The operating environment 200 also includes a processing unit 210, an optional display 240 and a memory 250, all interconnected along with the network interface 230 via a bus 220. Those of ordinary skill in the art and others will appreciate that the display 240 may not be necessary in all forms of computing devices and, accordingly, is an optional component. The memory 250 generally comprises random access memory (“RAM”), a read only memory (“ROM”) and a permanent mass storage device, such as a disk drive, flash RAM, or the like. The memory 250 stores the program code necessary for a lender selection routine 280 and an applicant selection routine 290. Additionally, the memory 250 stores an operating system 255 and a lender selection database 270.

It will be appreciated that the software components may be loaded from a computer readable medium into memory 250 of the operating environment 200 using a drive mechanism (not shown) or network mechanism (not shown) associated with the computer readable medium, such as a floppy, tape, digital video disc (DVD)/CD-ROM drive, flash RAM, network interface card, or the like.

Although an exemplary operating environment 200 has been described that generally conforms to conventional general-purpose computing device, those of ordinary skill in the art will appreciate that a operating environment 200 may be any of a great number of devices capable of functioning as a device, server or operating environment that is within the spirit or scope of the embodiments described herein or can perform at least one function of the embodiments described herein.

In one exemplary embodiment, a user can configure or interact with the operating environment 200 using a graphical user interface. An example of a graphical user interface is an interactive web page, e.g., in HTML (HyperText Markup Language), Flash, JavaScript, VBScript, JScript, PHP (HTML Preprocessor) or XHTML (eXtensible HyperText Markup Language) form, or the like. Resultantly, since users are generally familiar with the user interfaces of web pages, including sophisticated web pages such as Flash-enabled web pages from Macromedia, Incorporated of San Francisco, Calif., consumption of peer to peer device services using a web page based graphical user interface on a peer to operating environment 200 (e.g., displayed on the peer to peer display 240) may be made familiar and user friendly.

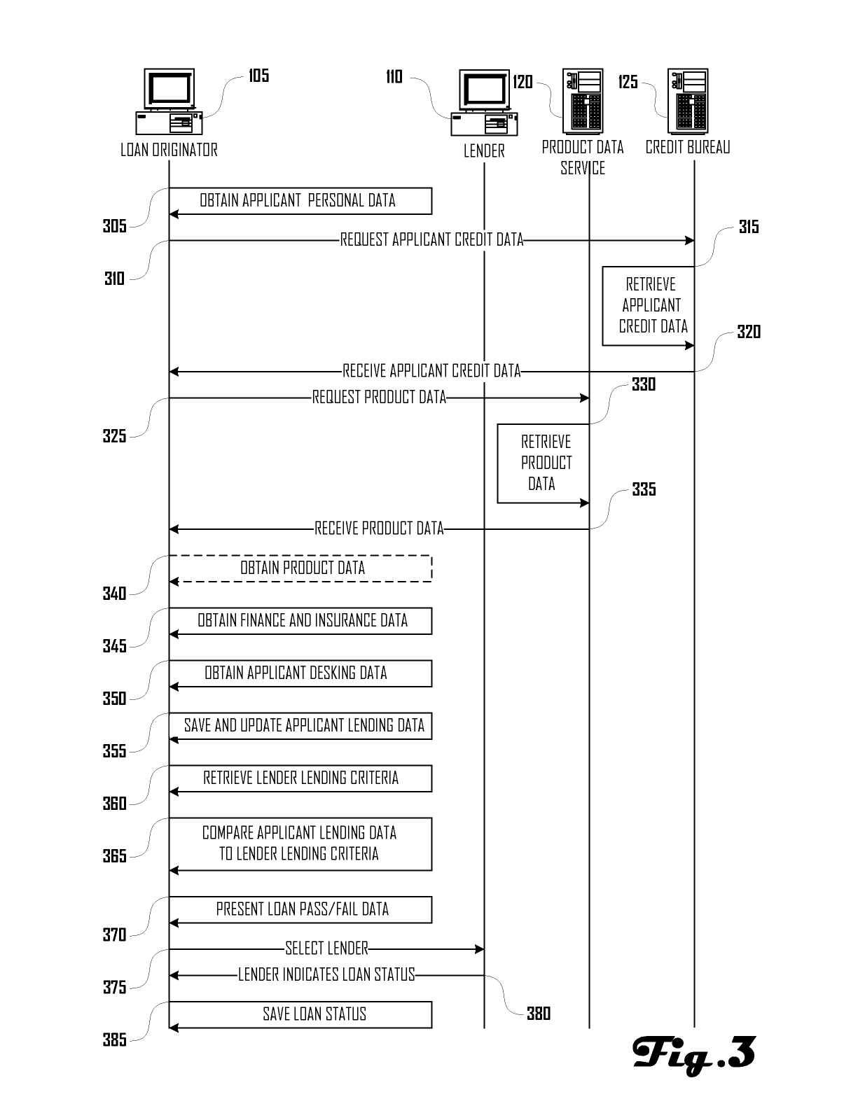

FIG. 3 is a diagram illustrating one exemplary series of communications between a loan originator 105, a lender 110, a product data service 120 and a credit bureau 125. The communications begin with the loan originator obtaining applicant personal data 305. Applicant personal data can comprise any information about a loan applicant, including but not limited to, name, known aliases, mailing address, phone number, date of birth, social security number, employment history, personal income history, assets and liabilities, bankruptcy history, criminal history, judgments or pending lawsuits, immigration status, citizenship, personal references, or the like.

Next, the loan originator 105 requests applicant credit data 310 from the credit bureau 125. The credit bureau 125 retrieves applicant credit data 315 and the loan originator 105 receives the applicant credit data 320. Applicant credit data can comprise any information about a loan applicant or the credit history or credit status of a loan applicant. For example applicant credit data can include applicant personal data; information about credit accounts with banks, retailers, credit-card issuers, utility companies, and other types of lenders; public records such as those involving bankruptcy, tax liens, monetary and non-monetary legal judgments; a list of persons or companies that have requested or obtained the applicant's credit data; one or more credit score, or the like.

Next, the loan originator 105 requests product data 325 from the product data service 120. The product data service 120 retrieves product data 330 and the loan originator 105 receives product data 335. Additionally or alternatively, the loan originator 105 can independently obtain product data 340. Product data can comprise any information about one or more product or service that an applicant desires to purchase with at least one loan. For example, if an applicant desires to purchase a vehicle from a vehicle dealership, product data would include information about the desired vehicle and possible information about similar vehicles or other vehicles that the user would desire to purchase alternatively.

Then, the loan originator 105 obtains finance and insurance data 345. Finance and insurance data can comprise information about desired financing terms or conditions and information about warranties, insurance or additional products or services associated with the primary one or more good or service that the customer desires to purchase.

Next, the loan originator 105 obtains desking data 350. Desking data is obtained or generated by compiling applicant personal data, applicant credit data, product data, and finance and insurance data, and using it to scrutinize the overall deal and make adjustments to any of the data or variables of the deal and thereby change the major terms of the deal. For example, the price, quality or quantity of a good or service can be changed to affect other variables such as loan amount requested, interest rate, and total monthly payment to be made on the loan. Conversely, variables such as loan amount requested, interest rate, and total monthly payment to be made on the loan can be changed to affect the price, quality or quantity of a good or service. Desking data can comprise any information about the deal as a whole, including one or more deal scenarios, which may depend on changes in one or more variable, piece of data, or piece of information.

Returning to the series of communications, the loan originator 105 then saves and updates applicant lending data 355, which comprises the all information obtained about the applicant, the transaction, and the one or more good or service associated with the transaction, including, but not limited to applicant personal data, applicant credit data, product data, applicant desking data, finance and insurance data, or the like.

Next, the loan originator 105 retrieves lender lending criteria 360 and compares the applicant lending data to the lender lending criteria 365 and presents loan pass/fail data 370. Lender lending criteria is any set of criteria that a given lender uses to determine if an applicant is eligible to receive a loan from the lender. The lender lending criteria can be based on one or more piece of information that comprises the applicant lending data or other information. Additionally, the lender lending criteria can be different for each lender where there is a plurality of lenders, and the lender lending criteria may not actually be the complete or actual set of criteria used by a given lender when the lender decides to accept or deny a loan application.

Pass/fail data generated from the comparison of applicant lending data to lender lending criteria 365 can be presented 370 in a multitude of different ways. For example, pass fail data can be a binary pass or fail response, can give an estimated percent chance of being granted the loan, or can present pass/fail or other response to any sub-set of the lender lending criteria. For example, a presentation of pass/fail data 370 can comprise an indication that the applicant is 50%, 60%, 70%, 80%, 90%, 95%, or any other percent, likely to be granted a loan from the lender based on the comparison of applicant lending criteria to lender lending criteria 365. In another example a presentation of pass/fail data 370 can comprise an indication that the applicant is “very unlikely,” “unlikely,” “likely” or “very likely” to be granted a loan from the lender. In yet another example, in addition to presenting the likelihood of whether the applicant will receive a loan from the lender, lenders can be prioritized or displayed according to the referral fee that will be paid by the lender to the loan originator. One reasonably skilled in the art and others will immediately appreciate the vast number of ways that loan pass/fail data can be presented 370 and that any of these methods are within the scope and spirit of the embodiments described herein.

Additionally, comparing applicant lending data to lender lending criteria 365 and generating and presenting loan pass fail/data 370 can be achieved in a multitude of manners, and can be according to any number of threshold requirements and one reasonably skilled in the art and others will immediately appreciate the vast number of ways that this can be achieved and that any of these ways is within the scope and spirit of the embodiments described herein.

Returning to FIG. 3, the loan originator selects the lender 375 and some or all of the applicant lending data is sent to the lender 110. The lender 110 then indicates the loan status 380 to the loan originator 105 and the loan originator 105 saves the loan status 385.

In one exemplary embodiment, one or more of the steps or communications depicted in FIG. 3 can be repeated one or more times before selecting a lender 375, or after the lender 110 indicates the loan status 380, or at any other time. For example, applicant personal data, applicant credit data, product data, applicant desking data, finance and insurance data, or the like, can be re-obtained, restructured, edited or the like, or additional data can be obtained. In other words, after loan pass/fail data is presented 375, or the lender 110 indicates loan status 380 the loan originator 105 can modify applicant lending data and then compare the modified applicant lending data to the plurality of lender lending criteria. Where there is a plurality of lenders 110, modification of applicant lending data can allow the loan originator 105 to increase the number of likely lending candidates, reduce the number of lending candidates, obtain a new set of likely lending candidates, or the like.

In a further embodiment, where there is a plurality of lenders 110, the loan originator 105 can receive an alert when too many or too few lenders 110 have been presented as being likely lending candidates. For example, if too many lenders 110 have been presented as being likely lending candidates, the loan originator 105 can receive an alert to request, or modify applicant lending data so as to request, more competitive loan terms, including, but not limited to increased loan amount, reduced interest rate; more favorable loan insurance terms, or the like.

In another exemplary embodiment there can be a plurality of lenders 110, and the loan originator 105 can select one or more lender 375 or not select one or more lender. Additionally, in a further embodiment, there can be a plurality of credit bureaus 125, the loan originator 105 can request and receive applicant credit data 310, 320 from a non-bureau source, or can receive applicant credit data from the applicant. In another exemplary embodiment, the loan originator 105 can be a lender selection server 105 or the loan originator 105 can configure a remote lender selection server 115 to achieve the series of communications as depicted in FIG. 3 and described herein. Additionally, in another embodiment, if a lender 110 indicates that a loan has been approved, the loan originator 105 can obtain a signature or electronic signature of the applicant and send electronic, facsimile or hard copies of the loan contract to the lender.

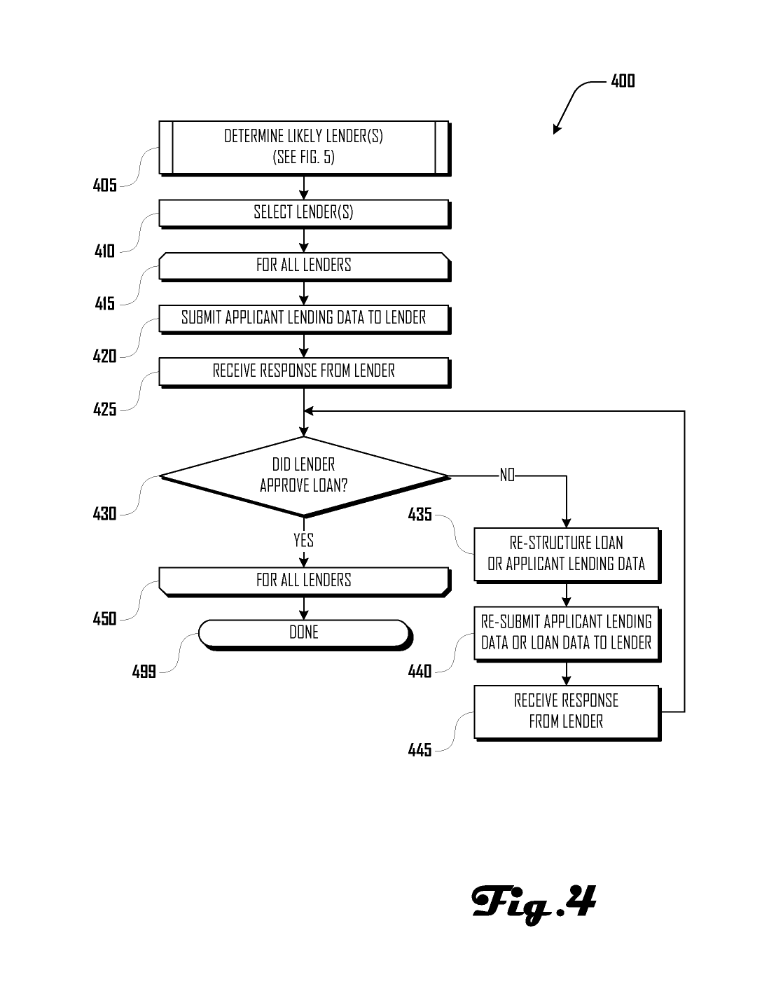

FIG. 4 is a flow diagram illustrating a routine for selecting and soliciting at least one lender 400 in accordance with various embodiments. The routine for selecting and soliciting at least one lender 400 begins at sub-routine block 405 where a routine is performed to determine at least one likely lender. In other words, one or more lender that is likely to grant the given applicant a loan is presented. The routine continues to block 410 where at least one lender is selected.

Next, looping block 415 begins a loop and the following actions are taken for all selected lenders. In block 420, applicant lending data is submitted to the lender, which can comprise some or all of the data that comprises the applicant lending data. Then, in block 425 a response is received from the lender and the routine continues to decision block 430 where a determination is made whether the lender approved a loan for the applicant. If the lender did not approve the loan, the routine continues to block 435 where loan or applicant lending data is re-structured, and then, in block 440, the re-structured applicant lending data or loan data is resubmitted to the lender. Next, in block 445, a response is received from the lender and the routine loops back to decision block 430, where a determination is made whether the lender approved a loan for the applicant. On the other hand, if the lender did approve a loan for the applicant, the routine proceeds to looping block 450, which cycles back to looping block 415 so long as applicant lending data has not yet been submitted to at least one selected lender. Once applicant lending data has been submitted to all lenders, the routine is done 499.

As described herein, one or more steps of the process can be repeated one or more times before selecting a lender 410, or after the lender indicates the loan status 425, or at any other time and where there is a plurality of lenders, modification of applicant lending data can allow the loan originator 105 to increase the number of likely lending candidates, reduce the number of lending candidates, obtain a new set of likely lending candidates, or the like.

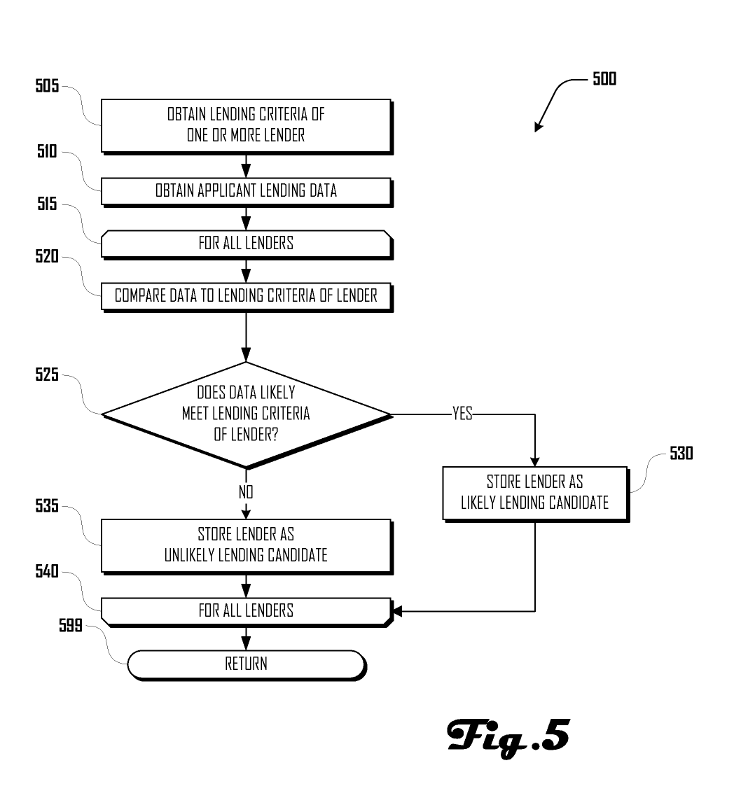

FIG. 5 is a flow diagram illustrating a sub-routine for selecting at least one lender 500 in accordance with various embodiments of the embodiments described herein. The sub-routine for selecting at least one lender 500 begins at block 505 where lending criteria of one or more lender is obtained, then the routine proceeds to block 510 where applicant lending data is obtained. Next, looping block 515 begins a loop and the following actions are taken for all lenders for which lender lending criteria for has been obtained 505. In block 520, applicant lending data is compared to the lending criteria of a lender, and then, in decision block 525, a determination is made whether the applicant lending data likely meets the lending criteria of the lender.

If the applicant lending data does likely meet the lending criteria of the lender, the routine continues to block 530, where the lender is stored as a likely lending candidate. The routine then proceeds to looping block 540, which cycles back to looping block 515 if applicant lending data has not been compared to the lender lending criteria of one or more lender. Returning to decision block 525, if the applicant lending data does not likely meet the lending criteria of the lender, the routine continues to block 535, where the lender is stored as an unlikely lending candidate. The routine then proceeds to looping block 540, which cycles back to looping block 515 if applicant lending data has not yet been compared to the lender lending criteria of one or more lender. Once the applicant lending data has been compared to the lender lending criteria of all lenders for which lender lending criteria has been obtained 505, the routine returns 599 to the routine selecting and soliciting at least one lender 400 as depicted in FIG. 4.

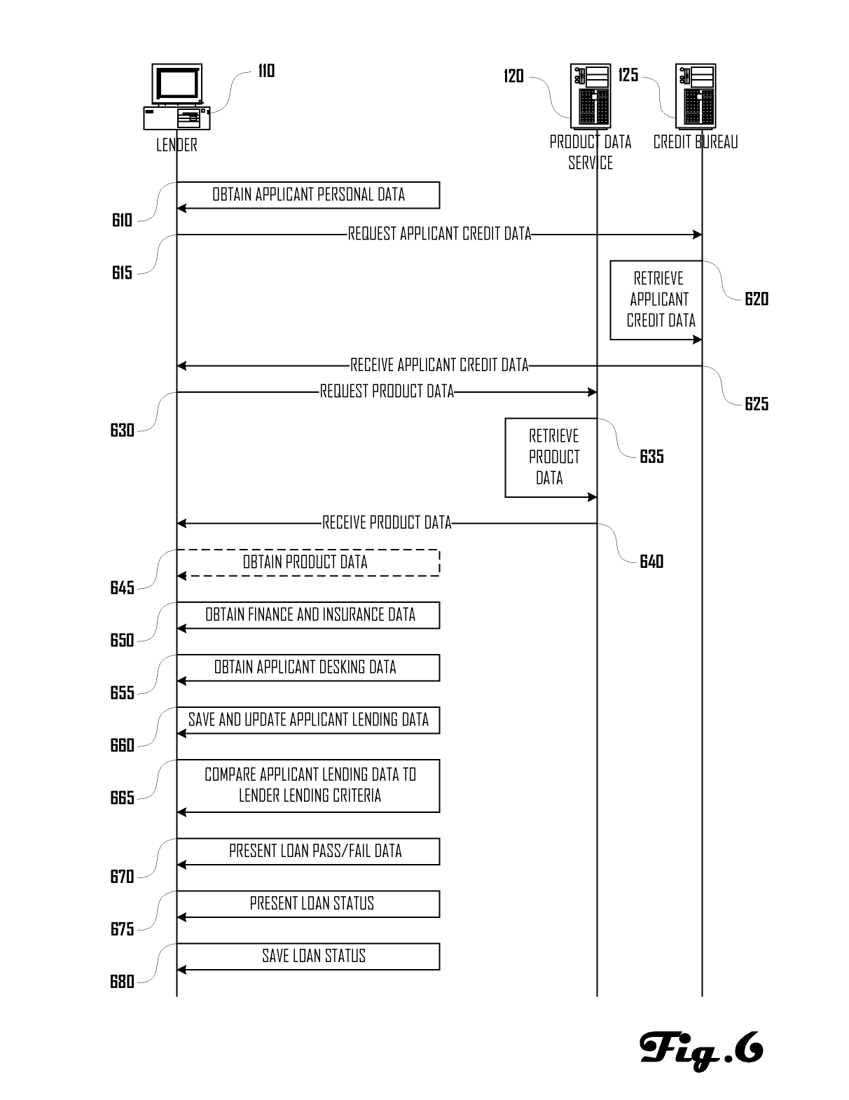

FIG. 6 is a diagram illustrating one exemplary series of communications between a lender 110, a product data service 120 and a credit bureau 125 while the lender is evaluating a lending applicant in accordance with various embodiments. The communications begin with the lender 110 obtaining applicant personal data 610. Next, the lender 110 requests applicant credit data 615 from the credit bureau 125, the credit bureau 125 retrieves applicant credit data 620 and the lender 110 receives the applicant credit data 625 from the credit bureau 125. The lender 110 then requests product data 630 from the product data service 120 and the product data service 120 retrieves product data 635 and the lender 110 receives product data 640 from the product data service 120. Additionally or alternatively, the lender 110 can independently obtain product data 645. Then, the lender 110 obtains finance and insurance data 650, obtains desking data 655 and saves and updates all of the applicant lending data 660. Next, the lender 110 compares the applicant lending data to the lender's lending criteria 665 and presents loan pass/fail data 670, indicates the loan status 675 then saves the loan status 680.

Additionally, in one exemplary embodiment, there can be a plurality of credit bureaus 125, the lender 110 can request and receive applicant credit data 615, 625 from a non-bureau source, or can receive applicant credit data from the applicant. In another exemplary embodiment, the lender 110 can communicate with and/or configure a remote lender selection server 115 to achieve the series of communications as depicted in FIG. 6 and described herein.

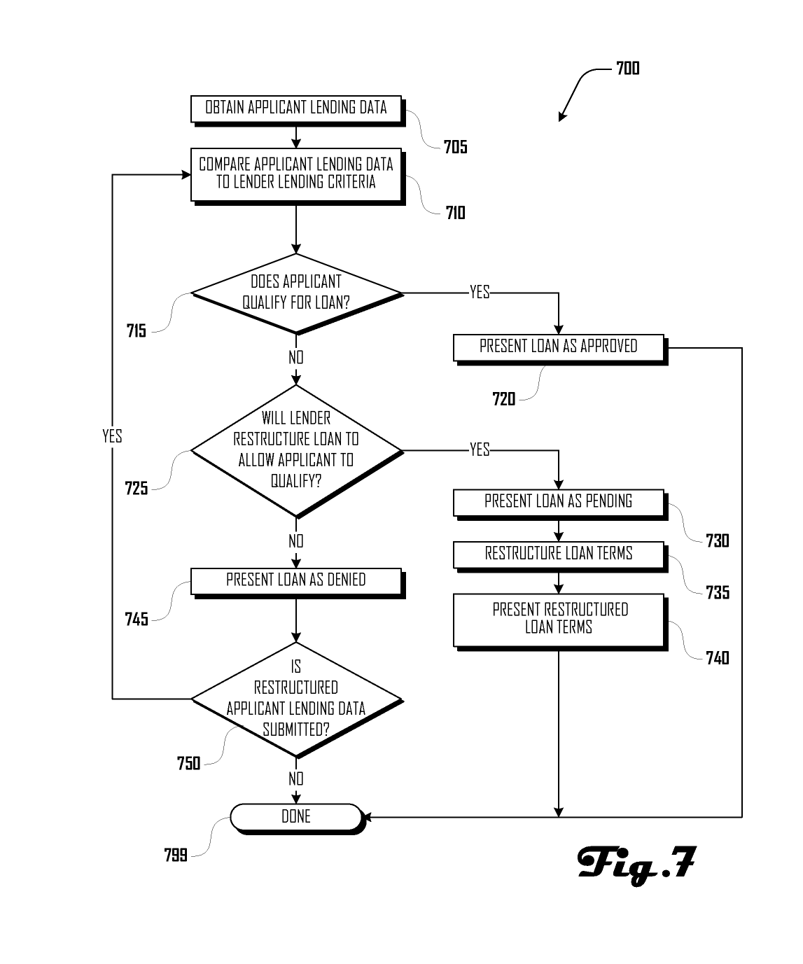

FIG. 7 is a flow diagram illustrating a routine for evaluating a lending applicant and restructuring a loan 700 in accordance with various embodiments. The routine begins at block 705 where applicant lending data is obtained. The routine continues to block 710 where the applicant lending data is compared to the lender lending criteria, and then, in decision block 715, a determination is made whether the applicant qualifies for a loan. If the applicant does qualify for a loan, the routine moves to block 720, where the loan is presented as approved, and the routine is done 799.

However, if the applicant does not qualify for a loan, the routine continues to decision block 725, where a decision is made whether the lender will re-structure the loan to allow the applicant to qualify. If the lender will not re-structure the loan to allow the applicant to qualify, the routine proceeds to block 745 where the loan is presented as denied and then to decision block 750 where a determination is made whether restructured applicant lending data is submitted to the lender. If restructured applicant lending data is submitted by to the lender, the routine loops back to block 710 where the newly submitted applicant lending data is compared to the lender's lending criteria. Alternatively, if restructured applicant lending data is not submitted by to the lender, the routine is done 799.

Returning to decision block 725, if it is determined that the lender will re-structure the loan to allow the applicant to qualify, the routine proceeds to block 730 where the loan is presented as pending. In other words, the lender indicates that they would be willing to proceed with the loan process, but with restructured terms. The routine then moves to block 735 where the loan terms are restructured, and then to block 740 where the restructured loan terms are presented and the routine is done 799.

Although specific embodiments have been illustrated and described herein, it will be appreciated by those of ordinary skill in the art and others, that a wide variety of alternate and/or equivalent implementations may be substituted for the specific embodiment shown in the described without departing from the scope of the embodiments described herein. This application is intended to cover any adaptations or variations of the embodiment discussed herein. Therefore, it is manifested and intended that the invention be limited only by the claims and the equivalents thereof. While preferred and alternate embodiments of the invention have been illustrated and described, as noted above, many changes can be made without departing from the spirit and scope of the invention. Accordingly, the scope of the invention is not limited by the disclosure of these preferred and alternate embodiments. Instead, the invention should be determined by reference to the claims that follow.

1. A computer implemented method of selecting one or more lender, the method comprising:
obtaining lender lending criteria of a plurality of lenders, wherein the lending criteria comprises lender non-bureau criteria;
obtaining applicant lending data of an applicant, wherein in the applicant lending data comprises applicant bureau data, applicant non-bureau data, and applicant loan purpose data;
comparing the applicant lending data to the lender lending criteria of at least one of the plurality of lenders; and
presenting at least one lender that is predicted to likely grant said applicant a loan.

2. The method of claim 1, further comprising selecting at least one of the at least one lender and submitting applicant lending data to the at least one lender.

3. The method of claim 2, further comprising obtaining lender indicated loan status of at least one loan from one or more lender.

4. The method of claim 3, further comprising re-structuring applicant lending data and comparing said re-structured applicant lending data to the lending criteria of at least one of the plurality of lenders.

5. The method of claim 4, further comprising re-structuring applicant lending data and submitting said re-structured applicant lending data to at least one lender.

6. The method of claim 1, wherein the applicant bureau data is obtained from a credit bureau.

7. The method of claim 1, wherein the applicant non-bureau data comprises product data and said product data is obtained from a product data service.

8. The method of claim 1, wherein the loan originator configures a remote lender selection server to perform the method of claim 1.

9. A computing device having a processor and a memory with computer executable instructions which, when executed by said processor, perform the method of claim 1.

10. A computer readable medium having executable instructions, which when executed perform the method of claim 1.

11. A computer implemented method of evaluating a lending applicant, the method comprising:
retrieving lender lending criteria for at least one lender, wherein the lending criteria comprises lender bureau criteria and lender non-bureau criteria;
obtaining applicant lending data of an applicant, wherein the applicant lending data comprises applicant bureau data, applicant non-bureau data, and applicant loan purpose data;
comparing the applicant lending data to the lender lending criteria;
determining if applicant lending data meets lender lending criteria for at least one lender; and
providing at least one lender that is predicted to likely grant said applicant a loan.

12. The method of claim 11, wherein the applicant lending data is obtained from a loan originator.

13. The method of claim 12, further comprising the step of presenting loan status to the loan originator.

14. The method of claim 13, further comprising the step of re-structuring loan terms where the applicant lending data fails to meet lender lending criteria and presenting re-structured loan terms to the loan originator.

15. The method of claim 11, wherein the loan originator is a vehicle dealership.

16. The method of claim 11, wherein the applicant bureau data is obtained from a credit bureau.

17. The method of claim 11, wherein the applicant non-bureau data comprises product data and said product data is obtained from a product data service.

18. The method of claim 11, wherein the lender configures a remote lender selection server to perform the method of claim 11.

19. A computing device having a processor and a memory with computer executable instructions which, when executed by said processor, perform the method of claim 11.

20. A computer readable medium having executable instructions, which when executed perform the method of claim 11.
